(19) United States
(12) Patent Application Publication
(10) Pub. No.: US 2013/0080871 A1
(43) Pub. Date: Mar. 28, 2013

(54) METHOD FOR RETRIEVING A REPRESENTATION OF AN ANNOTATED WEB DOCUMENT, ASSOCIATED COMPUTER PROGRAM AND ELECTRONIC DEVICE

(71) Applicant: MYRIAD GROUP AG, Zurich (CH)

(72) Inventors: Roy HOWARTH, Stalybridge (GB); Ed Nurse, Manchester (GB)

(73) Assignee: MYRIAD GROUP AG, Zurich (CH)

(21) Appl. No.: 13/627,137

(22) Filed: Sep. 26, 2012

(30) Foreign Application Priority Data
Sep. 27, 2011 (FR) FR 11 586 21

(51) Int. Cl. G06F 17/00

(52) U.S. Cl. 715/230

(57) ABSTRACT

A method for retrieving a representation of an annotated Web document, the annotated Web document being a Web document having at least one added annotation, the annotated Web document including an upper Web element including at least one annotation and at least one lower Web element arranged below the upper Web element, is implemented by an electronic device comprising a viewer, an Internet browser application, and an annotation application. The method includes displaying the annotated Web document by (i) detecting a touch or mouse event associated with the upper Web element, (ii) hiding the upper Web element after the detection of said event, (iii) determining a target Web element corresponding to the lower Web element situated directly below said event, and (iv) sending the event to the target Web element.

This claims the benefit of French Patent Application FR 11 586 21, filed Sep. 27, 2011 and hereby incorporated by reference herein.

The present invention relates to a method for retrieving a representation of an annotated Web document, the Web document having at least one added annotation, the annotated Web document including an upper Web element comprising at least one annotation and at least one lower Web element arranged below the upper Web element, the method being implemented by an electronic device comprising viewing means, an Internet browser application, and an annotation application, the method including the following step:

displaying the annotated Web document including the or each added annotation.

The invention also relates to a computer program product including the software instructions that, when run by a processing unit integrated into an electronic device including data viewing means and an Internet browser application, carries out the steps, for which the annotation application is responsible, of such a retrieval method, relative to a Web document.

The present invention also relates to an electronic device comprising:

a processing unit,

data viewing means,

an Internet browser application, and

an annotation application capable of retrieving and/or adding at least one annotation on a Web document, the annotation application including a module for reading the annotation(s) capable of retrieving a representation of an annotated Web document, the annotated Web document being the Web document in which at least one annotation has been added, the annotated Web document comprising an upper Web element including at least one annotation and at least one lower Web element arranged below the upper Web element.

### BACKGROUND

An annotation is a graphic element associated with a document and comprises non-native content of the document filled in by a user. Such annotations thus allow users to share information, suggestions, impressions, etc. relative to a Web document via the Web document itself, rather than using a messaging system, for example.

These annotations assume the form of a freehand drawing, a note, a link, or an image pointing to an element of the Web document to which it refers. The annotation for example assumes the form of an ellipse drawn by the user around a selectable hypertext link, so as to highlight the link.

Annotating a Web document comprises displaying, using the browser application, a toolbar adapted to the creation and positioning of annotations on the document handled by the browser application and viewed. The added annotations, as well as the toolbar, are superimposed on the representation of the Web document generated by the browser application.

A retrieval method and an electronic device of the aforementioned type are known. Such a retrieval method allows a user, using such an electronic retrieval device, to view the added annotations, added by the user himself or another user, on that Web document using the electronic annotation device, such as a computer or a mobile telephone. The retrieved annotations are superimposed on the representation of the Web document generated by the browser application.

### SUMMARY OF THE INVENTION

However, using such an electronic device implementing such a retrieval method does not make it possible to select a hypertext link around which an annotation has been added.

It is an object of the present invention to provide a retrieval method making it possible, by implementing the associated electronic device, to select a hypertext link around which an annotation has been added, so as to facilitate the use of the electronic device.

The present invention provides a retrieval method of the aforementioned type, characterized in that the display step includes:

(i) detecting a touch or mouse event associated with the upper Web element,

(ii) hiding the upper Web element after the detection of said event,

(iii) determining a target Web element corresponding to the lower Web element situated directly below said event, and

(iv) sending the event to the target Web element.

According to other advantageous features of the invention, the retrieval method comprises one or more of the following features, considered alone or according to all technically possible combinations:

the detection of the event includes triggering the input of touch or mouse event(s) associated with the upper Web element,

the sending of the event includes creating a replica of the event, then sending the created replica to the target Web element,

the display step also includes, after step (iii): displaying the upper Web element that was previously hidden,

the hiding of the upper Web element includes positioning a CSS visibility attribute corresponding to the upper Web element in the hidden state,

the display of the previously hidden upper Web element includes positioning a CSS visibility attribute corresponding to the upper Web element in the visible state,

the Web document is an HTML document, and the Web element is an HTML element, and

the upper Web element is an HTML element capable of performing dynamic rendering of an image using a script.

The invention also relates to a computer program product including software instructions which, when run by a processing unit integrated into an electronic device including data viewing means and an Internet browser application, carries out the steps, for which the annotation application is responsible, of the retrieval method as defined above, relative to a Web document.

The invention also relates to an electronic device of the aforementioned type, characterized in that the read module comprises means for detecting a touch or mouse event associated with the upper Web element, means for hiding the upper Web element following the detection of said event, means for determining a target Web element corresponding to the lower Web element located directly below said event, and means for sending the event to the target Web element.

According to another advantageous aspect of the invention, the electronic device comprises the following feature:

the device includes means for injecting said annotation application into the document to add on to the document, and the browser application comprises a module for managing the graphic interface for accessing the Internet and a module for managing document rendering defining a context for running the rendering management module, said context comprising the source and processed data of the rendering management module, wherein the annotation application can be run from the extended document only in the context of execution of the rendering management module on the source and processed data of the document rendering management module and using the same functions as the rendering management module, and wherein the document processed by the browser application includes graphic elements, the annotation application being adapted to anchor an annotation to a point of a graphic element of the document independently of the coordinates of the graphic element in the document.

### BRIEF DESCRIPTION OF THE DRAWINGS

These features and advantages of the invention will appear upon reading the following description, provided solely as an example, and done in reference to the appended drawings, in which:

FIG. 1 is a diagrammatic illustration of an overall system including an electronic device adapted to implement the method according to the invention,

FIG. 2 is a diagrammatic illustration of a source representation of a Web document according to a first aspect of the invention,

FIG. 3 is a diagrammatic illustration of a target representation of the same document as FIG. 2,

FIG. 4 is a flowchart of an overall method for annotating a Web document and retrieving the annotated Web document, and

FIG. 5 is a flowchart of a method according to the invention.

### DETAILED DESCRIPTION

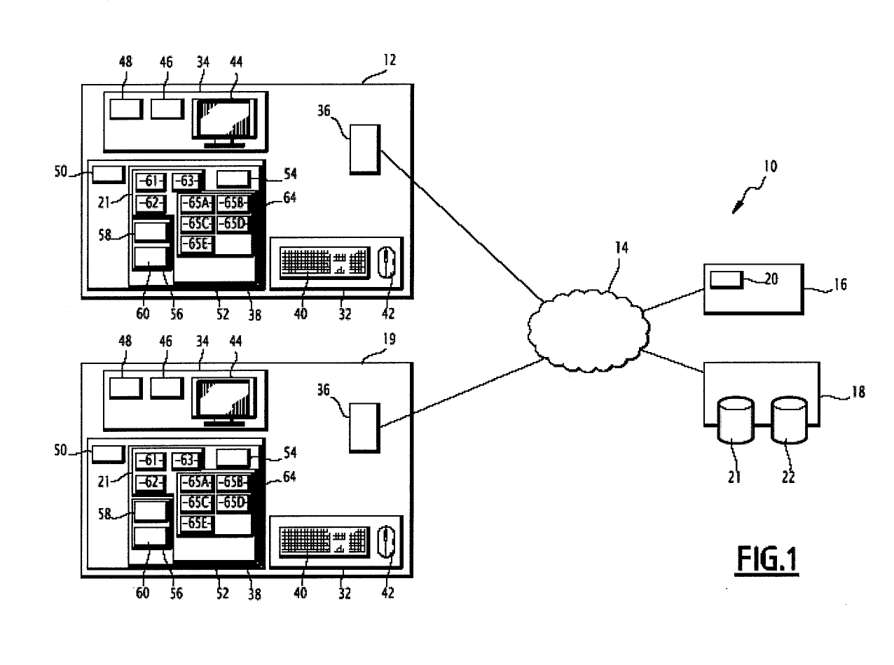

In reference to FIG. 1, the overall system 10 includes an electronic device 12 adapted to interact with the Internet network 14 so as to establish communication with at least one Web server 16, an annotation management server 18, and another electronic device 19.

In a known manner, the Web server 16 is adapted to store Web documents 20. The Web server 16 is also adapted to process a request it receives from the electronic device 12, 19. Traditionally, the processing of the request by the Web server 16 results in the latter sending a document it contains to the electronic device from which the request emanates.

The annotation management server 18 can store an application 21 for annotating a Web document and annotation data 22 for the Web document, the annotation data 22 comprising annotations 23 added to the corresponding Web document 20.

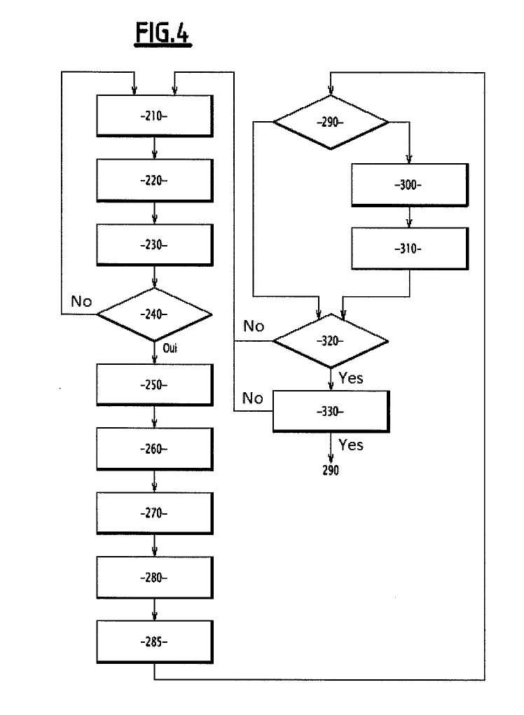

An annotated Web document 24, which can be retrieved by the electronic device 12, 19, is a Web document 20 on which annotations 23 have been added, as shown in FIG. 3. The annotated Web document 24 includes an upper Web element 25A comprising an annotation and at least one lower Web element 25B, 25C arranged below the upper Web element 25A, the or each lower Web element 25B, 25C forming the Web document 20.

The Web document 20 and the annotated Web document 24 are for example HTML (HyperText Markup Language) documents, and the or each Web element 25A, 25B is an HTML element.

The electronic device 12 for example consists of a personal computer, a mobile telephone, or a touchscreen tablet. The electronic device 12 includes means 32 for entering information generated by a user, viewing means 34, telecommunications means 36, and a central processing unit 38 adapted to run applications necessary for the operation of the electronic device 12.

The other electronic device 19 is similar to the electronic device 12, and includes the entry means 32, viewing means 34, telecommunications means 36, and central unit 38.

In a known manner, the viewing means 34 include a screen 44 and means for processing graphic information, for example a graphic processor 46 and associated graphics memory 48.

In a known manner, the input means 32 include a keyboard 40 from which the user can command the execution of software, functionalities of that software, add text to a document, etc. The input means 32 also include means for interacting with information displayed on the viewing means 34, for example such as a mouse 42 handled by a user. In the considered case, the mouse 42 comprises a button can be actuated by pressure from the user on the button (a click), the button then being able to be released or kept pressed by the user.

The graphic processor 46 is adapted to process the graphic information stored in the graphics memory 48 and to display that information or a representation thereof on the screen 44.

Advantageously, the input means 32 and the viewing means 34 may have a shared form, in the case of a touchscreen, for example.

The telecommunications means 36 include a network interface allowing the electronic device 12 to communicate with other devices of the network 14, for example the Web server 16, the annotation management server 18, or the electronic device 19.

The central processing unit 38 includes a processor 50 and one or more memories 52.

The processor 50 is adapted to run applications contained in memory 52, in particular an operating system allowing the traditional operation of an electronic device.

The memory 52 includes different memory zones, statically or dynamically allocated, which contain applications intended to be run by the computer device 12.

The memory 52 is capable of storing the annotation application 21, an application 54 for sending requests, and a browser application 56.

The request-sending application 54 serves to instruct the electronic device 12 to send a request to a remote device using its communication means 36.

When the request-sending application 54 is run by the device 12, a network connection is done using a communication protocol, for example the HTTP (HyperText Transfer Protocol) protocol, and a request, for example an HTTP request, is sent through the network 14 to a remote device connected to the network.

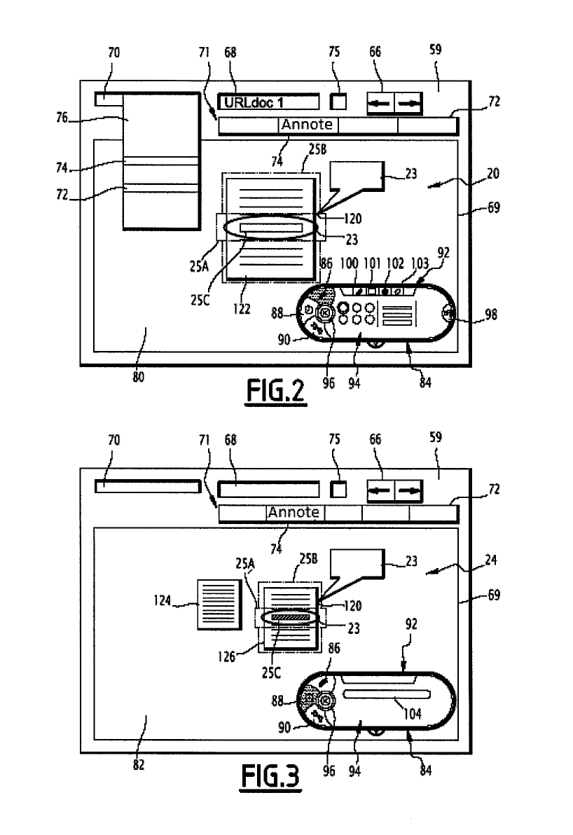

In a known manner, when the remote device is a server and the request is an HTTP request containing the so-called URL (Universal Resource Locator) address of a resource stored in the remote device, for example a Web document 20, visible in FIG. 2, the server returns the requested resource to the electronic device 12.

The purpose of the browser application 56 is to allow the user to access content, for example the Web document 20, view it on the viewing means 34, and interact with its content, in particular using a graphic interface 59 of the application 56.

In a known manner, the browser application 56 includes at least one module 58 for managing a graphic interface 59 for accessing a network and a rendering management module 60.

These modules correspond to software subassemblies of the browser application 56 that implement the functions making them up.

The purpose of the interface management module 58 is to drive graphic interface elements 59 of the browser application 56 and ensure connection to the network to request and receive a particular Web page.

The annotation application 21 comprises an annotation module 61 capable of adding annotations on the Web document 20, a module 62 for archiving annotations added on the Web document 20 on different annotation dates by at least one user, and a module 63 for sharing the added annotations with other users, as shown in FIG. 1 when the annotation application 21 is stored in the memory 52 of the electronic device.

According to a first aspect of the invention, the annotation application 21 also comprises a module 64 for reading annotations 23 archived or added by the user himself. In other words, the read module 64 is capable of displaying the annotated Web document 24, i.e. of retrieving the annotations 23 on the Web document 20.

The annotation module 61 allows the user to select an annotation element (for example a text box, image, freehand drawing), modify certain attributes thereof (for example, the color or size) to obtain a customized invitation, then position the annotation on the Web document 20.

The archiving module 62 is capable of generating the annotation data 22 associated with said Web document 20, the annotation data 22 comprising the added annotations on said Web document 20.

The archiving module 62 is capable of transmitting the generated annotation data 22 to the annotation management server 18 for archiving thereof via the communication means 36. The sharing module 63 is capable of transmitting a URL associated with the annotated Web document to another user via the communication means 36. The URL associated with the annotated Web document is sent in the form of a hypertext link in an electronic mail, also called e-mail, or in the form of a hypertext link in a message on an Internet social network, such as Facebook© or Twitter©.

The read module 64 includes means 65A for detecting a touch or mouse event associated with the upper Web element 25A, and means 65B for hiding the upper Web element 25A following the detection of said event.

The read module 64 includes means 65C for determining a target Web element 25C corresponding to the lower Web element located directly below said event, and means 65D for sending the event to the target Web element 25C.

Additionally, the read module 64 includes means 65E for displaying the previously hidden upper Web element 25A.

The set of touch events comprises a touchstart event when the finger makes contact with the touchscreen, a touchend event when the finger is removed from the touchscreen, a touchmove event when the finger is moved along the surface of the touchscreen, a touchenter event when the finger is placed in contact with an activatable zone defined by a DOM element, a touchleave event when the finger is removed from an activatable zone defined by a DOM element, and a touchcancel cancel event.

The set of mouse events comprises an onclick event for a single click, an ondblclick event for a double-click, an onmousedown event when the mouse button is depressed, without necessarily releasing it, an onmousemove event when the mouse cursor is moved, an onmouseout event when the mouse cursor is removed from the corresponding Web element, an onmouseover event when the mouse cursor is positioned on the corresponding Web element, and an onmouseup event when the mouse button is released. The mouse events are DOM (Document Object Model) events recommended by the W3C (World Wide Web Consortium). The mouse events are for example HTML events.

The detection means 65A can trigger the capture of touch or mouse events associated with the upper Web element.

The hiding means 65B can position a CSS (Cascading Style Sheet) visibility attribute corresponding to the upper Web element 25A in the hidden state.

The default value or default state of the CSS visibility attribute is ‘visible,’ for which the Web element associated with the CSS visibility attribute is visible. When the CSS visibility attribute value is set to ‘hidden’, the Web element associated with the CSS visibility attribute is hidden.

The determination means 65C can determine the target Web element 25C corresponding to the lower Web element located directly below said event when the upper Web element is hidden.

The sending means 65D can create a replica of the event, then send the created replica to the target Web element 25C. The target Web element 25C is for example a hypertext link to another Web document, and the sending of the touch or mouse event will then create the request to display the other Web document.

The display means for the previously hidden upper Web element 65E can position the CSS visibility attribute corresponding to the upper Web element in the visible state.

The upper Web element 25A depends on the type of annotation 23 chosen by the user. The upper Web element 25A is for example an HTML element that can perform dynamic rendering of an image using a script, when the annotation 23 is a freehand drawing. In the embodiment of FIGS. 2 and 3, the upper Web element is the canvas element set out by the HTML5 standard.

Alternatively, the upper Web element 25A is an image element, such as an HTML image element, also called IMG element and referenced using the <img> attribute known in itself.

In a known manner, and in reference to FIGS. 2 and 3, the elements of the graphic interface 59 include scroll buttons 66 for scrolling between the viewed documents, a navigation bar 68, a display frame 69 inside which the Web document 20 can be displayed, a drop-down menu bar 70, and a bookmark bar 71. The user then interacts with these elements using the input means 32.

The purpose of the rendering management module 60 is to drive all of the functionalities associated with the processing of documents and to display them on the viewing means 34.

In a known manner, the purpose of this management module 60 is to generate a representation of the document, add graphic elements to the viewed document, run the multimedia content of the document, execute the scripts located therein, and interact with the user's actions.

During the operation of the browser application 56, the reception of elements associated with the Web page the user wishes to view triggers the processing thereof by the central unit 38 and their sending to the rendering management module 60. The latter then builds a representation of the document, which is then saved in the memory 46 of the viewing means 34, then displayed on the screen 44.

This rendering management module 60 corresponds to the heart of the navigation application 56 and is based on the use of standard languages and technologies recommended by the W3C. These technologies for example include HTML, CSS, and JavaScript, which is a language for handling objects provided by an application, such as the annotation application 21.

In this way, an application driven by the management module of a browser application can be adapted to different browser applications.

In a known manner, a Web document 20 is built using a mark-up language, for example HTML. Other languages and technologies commonly used to build such a document are the XML (Extensible Markup Language), JavaScript, CSS, etc.

The markup language allows a developer, content creator, etc. to build a document by adding semantically marked-up elements thereto. The tags are then processed by the rendering management module 60, which generates a logic representation of the document therefrom with which the modules of the application interact.

In a device according to the invention, the rendering management module 60 implements the logic representations of the Document Object Model (DOM) type. A DOM representation of the document defines the logic structure of the document in a tree structure form. Each node of the tree structure corresponds to the structured document, for example an image, the text block, a link, etc.

Each node includes so-called “child” nodes situated one level lower in the tree structure. Each of the children of this node corresponds to a logic portion of the document with a higher granularity than that node, i.e. with greater detail.

Thus, the first rank node of the DOM representation corresponds to the entire document, its children correspond to the main logic portions of the document, their children to the logic portions of those main logic portions, etc.

Hereafter, the data “processed” by the rendering management module 60 corresponds to the DOM representation of the document from which a representation is created that is displayed on the viewing means 44. The so-called “source” data of the module 60 corresponds to the data—for example the HTML code—of the document necessary for the module 60 to produce the DOM representation thereof.

The browser application 56 also includes several functionalities illustrated in FIGS. 2 and 3.

In a known manner, one of these functionalities allows the user to enter the URL of a resource he wishes to access into the browser using a navigation bar 68.

The browser application 56 is also adapted to allow the user to generate bookmarks 72 allowing him to access a given resource more quickly.

Traditionally, these bookmarks 72 can be replaced by “scripted” bookmarks 74 (also called bookmarklets).

This bookmark creation functionality is driven by the interface management module 58 and is for example implemented using a dedicated shortcut button 75 in the form of tabs on the bookmark toolbar 71 and/or in a drop-down menu 76 accessible from the drop-down menu 70.

In a known manner, when the user wishes to create a bookmark 72 associated with a specific resource, he uses the mouse 42 to click on the shortcut button 75. The interface management module 58 orders the central processing unit 38 to run a command resulting in creating a bookmark 72 accessible a later time using the tab on the bookmark bar 71 and/or using a tab in the drop-down menu 76.

When the user wishes to access a resource with which a bookmark 72 is associated, he clicks the mouse on the corresponding tab in the drop-down menu 76. The browser then runs the command resulting in sending a request via the computer device 12 to a remote server on which the resource corresponding to the bookmark 72 is stored.

The function of the scripted bookmark 74 is to allow, aside from access to a resource, the execution of the script, for example JavaScript, which is contained in the scripted bookmark. Thus, a richer functionality than simple access to the resource may be associated with a bookmark 72 by means of a scripted bookmark 74, which replaces it in the drop-down menu 76. In a known manner, the scripted bookmark 74 makes it possible to modify the viewed document, view a search engine, run a particular request, etc.

In the considered embodiment, the annotation application 21 can be implemented by the electronic device 12 relative to a Web document, for example after having been “injected” into the document beforehand. The injection is done as follows: a specific scripted bookmark 74 hereafter called “Annoter scripted bookmark” creates a <script> element in the document using the standard JavaScript function document.createElement(‘script’), then assigns the source of that script to a JavaScript file located on the annotation management server 18 by modifying the src attribute of the <script> element previously created. Lastly, the <script> element is added into the document using the standard JavaScript function document.body.appendChild(s), where S is the <script> element previously created, which results in triggering the injection, then execution of the JavaScript file to which S points.

In computer science, the injection of an application into a document refers to the addition of the code and functions that make up the application into the document.

In practice, the application 21 uses code including functions and scripts in HTML, CSS and JavaScript, as will be seen hereafter.

When the application 21 is injected into the document, these functions and scripts are added to those making up the document itself.

The application 21 thus produces an add-on of the document.

The purpose of the annotation application 21 is to allow a user to add and view annotations 23 in a Web document 20. These annotations 23 may have been generated by the user or by another user on another representation of the document. This representation may itself for example have been generated from another computer device 19.

More particularly, the annotation application 21 is adapted to restore an annotation added to a so-called “source” representation 80 (i.e. the rendering of the document generated by the rendering management module 60 from the DOM representation of the document with which the rendering management module 60 interacts) of a Web document 20 on a so-called “target” representation 82 of the same document. Two representations of the same document may vary substantially from one to the other due to differences between the viewing means used, the sizes of the viewing windows, the size of the fonts used, the zoom levels used, etc.

The application 21 is also adapted to communicate with the annotation management server 18 via the communication means 36 of the computer 12 so as to obtain the information it needs to operate, as will be seen hereafter.

The annotation application 21 includes an annotation creation functionality on a representation of a Web document 20 and a functionality for restoring an annotation associated with a document.

The annotation creation functionality allows a user to create a customized annotation 23, for example an image, a text block, free text, etc. and to associate it with a graphic element included in the document.

To that end, the annotation application 21 allows the user to select the type of annotation 23 he wishes to add, the content of the annotation, a so-called “source” element of the representation with which the annotation is associated, the position of the annotation relative to that source element, etc.

These functions are implemented using a toolbar 84, generated on the viewing means 34 by the rendering management module 60 during execution of the annotation application 21 on the electronic device 12, with which the user can interact.

The toolbar 84 forms a man-machine interface between the user and the various modules of the annotation application 21 so as to allow the user to add an annotation on the Web document 20, by selecting an annotation element (e.g. a text box, an image, a freehand drawing), modifying certain attributes (e.g. color or size) to obtain a customized annotation, then positioning the elements on the Web document 20, or to share added annotations with other users, or to display annotations.

The toolbar 84 comprises three mode tabs 86, 88, 90, respectively corresponding to three distinct interaction modes between the user and the annotation application 21, i.e. a first mode tab 86 symbolized by a pencil and making it possible to select an annotation addition mode, visible in FIG. 2, a second mode symbolized 88 by a clock and making it possible to select an annotation display mode, visible in FIG. 3, and a third mode tab 90 symbolized by two people connected by an arrow and making it possible to select a mode, not shown, for sharing added annotations with other users.

The toolbar 84 comprises an upper bar 92 in the central zone 94 in which the display elements vary as a function of the interaction mode selected by the user, as well as a button 96 to close the annotation application, symbolized by an X surrounded by a circle.

The three mode tabs 86, 88, 90, the upper bar 92, the central zone 94 and the close button 96 are predefined selectable zones, also called predefined active zones. In other words, clicking using the mouse 42, or touching in the case of a touchscreen, on the corresponding selectable zone creates an action associated with the corresponding application, such as the annotation application 21 in the case of selectable zones of the toolbar 84.

In the annotation mode, shown in FIG. 2, the toolbar 84 comprises a tab 98 for canceling the last entry done, and four upper tabs 100, 101, 102, 103, respectively, arranged in the upper bar 92 and associated with distinct modes respectively for inputting annotations and free text entry using the cursor, which can be moved using the mouse 42. Each of these entry modes can be selected by clicking on the associated zone by positioning the cursor over the zone using the mouse 42 and clicking on the mouse button once the cursor is located in the zone. Selecting a zone among the zones 100, 101, 102, 103 results in displaying a toolbar 84 specific to the selected zone.

In the annotation display mode, shown in FIG. 3, the toolbar 84 comprises an information zone 104 relative to the annotated Web document being displayed.

In the considered embodiment, the toolbar 84 can keep its position relative to the display frame 69 during horizontal and/or vertical scrolling of the Web document 20 inside the display frame 69, while being movable relative to the display frame 69 upon specific action by the user. In other words, the toolbar 84 remains in its initial position on the viewing means 34 when the user scrolls the Web document 20 vertically and/or horizontally. The toolbar 84 can be moved by clicking, using the mouse 42, over a zone of the toolbar 84 (other than the zones associated with the functions described above), then performing a drag-and-drop operation using the mouse toward the selected location. This makes it possible to be able to add an annotation to any location of the Web document 20.

In the considered embodiment, the annotation application 21 only interacts with the rendering management module 60 to generate or retrieve annotations 23 on the documents: it only processes data contained in the registries specific to the rendering management module 60 and with functions specific to the rendering management module 60, without using other data or functions of the browser application 56 outside the rendering management module 60. The annotation application 21 thus uses the HTML, CSS, and JavaScript technologies. HTML and CSS are used to implement the annotation application viewing, and JavaScript is used to implement communication with the annotation management server 18 as well as the application logic, i.e. the manner in which the application 21 reacts to the user's actions.

In another embodiment, the annotation application 21 uses other data or functions of the browser application 56 outside the rendering management module 60, while being executed in the “context” of the browser application 56.

When a user clicks on a predefined zone using this mouse 42, or using one of his fingers in the case of a touchscreen, the click of the mouse as well as the position (x, y) on the viewing screen are identified and interpreted by monitoring software 100 of the annotation application 21, using functionalities of the rendering management module 60.

Depending on the type of annotation created, the annotation application 21 defines an anchor point 120 associated with the annotation 23. For example, the anchor point 120 of an image is the center of the image unless that image shows an arrow, in which case the anchor point defined will be the end of the tip of the arrow. Furthermore, the anchor point of free text is defined as the first point of the first line made by the user using the input means.

For each annotation, the coordinates (X, Y) of its anchor point are determined relative to the upper left corner of the page.

By running the standard DOM JavaScript routine document.elementFromPoint( ) the application 21 extracts the values of parameters of the so-called “source” element 122 (i.e. the corresponding node of the DOM representation from which the source representation 80 is generated) of the source representation 80 that includes the (X, Y) coordinate point with which the annotation 23 is then associated.

These parameters—which include inter alia the shift in coordinates between the anchor point 120 of the annotation 23 and the element 122—have separate degrees of importance.

The so-called essential parameters include the element type (image, text, etc.).

The so-called high importance parameters include an identification datum ID, a source datum of the source element 122—for example its URL—and the HTML textual content of the element—for example when the source element 122 is a paragraph.

The so-called low importance parameters include the coordinates of the source element 122 relative to the upper left corner of the page.

The values of these parameters are stored, as well as identification information for the document to which the annotation is attached. All of this data defines the annotation data 22.

The annotation data 22 generated by the annotation application 21 during the creation of an annotation 23 is then communicated to the annotation management server 18, which stores it.

This annotation data 22 is then necessary for the annotation application 21 to restore annotations 23 associated with documents viewed on a device 12 according to the invention.

To that end, the application runs the DOM JavaScript routine document.getElementsByTagName( ) from the value of the source element type, which returns a table of candidate elements 124 having for type the source element 122 type with which the annotation 23 is associated. This table is then stored in memory.

From that table, a sub-table of candidate elements 124 is generated by the application 21 from the candidate elements 124, at least one of the values of the high importance parameters being equal to that of the corresponding parameter of the source element 122.

In practice, the comparison of the properties of the elements is done from a hash of the properties. For computation cost reasons, this hash only includes a portion of the value of said properties, for example the first or last 32 characters thereof.

If a single candidate element 124 matches, it is selected as the anchoring element 126 for the corresponding annotation.

If more than two elements match, the coordinates of the candidate elements 124 are compared. The element whereof the coordinates in the target representation 82 are closest to the coordinates of the source element 122 in the source representation 80 is selected.

If no element matches, the preceding comparison is reiterated from the table of all of the candidate elements 124.

If the annotation application 21 still does not identify an anchor element 126, the coordinates of the anchor point 120 of the annotation 23 and the source representation 80 are used to reposition the annotation 23 on the target representation 82.

In practice, once an anchor element 126 is identified, the annotation application 21 obtains its coordinates and positions the annotation 23 relative to that anchor element 126 by making that relative position correspond to the position of the annotation 23 relative to the source element 122.

The application 21 then modifies the DOM representation generated by the rendering management module 60, which then displays the annotation 23 directly on the target representation 82 of the document it generates on the viewing means 34.

The application 21 thus proceeds by anchoring a newly created annotation 23 to an element of the considered document.

In the device 12 according to the invention, the annotation application 21 does not need to be installed prior to use.

When the user of the annotation application 21 wishes to add an annotation 23 to a Web document 20, he implements the application 21 using a scripted bookmark 74 of his browser application 56. The application 21 is then downloaded by the annotation management server 18 onto the computer device 12, then injected into the document.

In one embodiment, the scripted bookmark 74 is generated automatically by the annotation management server 18 when the user registers there to be able to use the application 21. The scripted bookmark 74 is inserted into a webpage presented to the user by the annotation management server 18 as a URL having a text or image attribute inviting the user to save the URL as a bookmark.

Such a method for deploying the application 21 on an electronic device is adapted to all devices whereof the browser application(s) 56 have a rendering management module 60.

Using standard technologies—HTML, CSS, JavaScript, etc.—that the application 21 uses to operate, and because it is injected into the Web document, it also does not require any modification to the browser application 56 to operate, and is not based on any proprietary technology of a given browser application 56.

The annotation application 21 is therefore adapted to allow the user to add and view annotations on the Web document 20 using all browser applications, in particular browser applications implemented on mobile telephones.

Furthermore, storing the application 21 on the annotation management server 18 makes it easier to update, for example when the annotation method it implements is modified.

In fact, only the application 21 located on the annotation management server 18 must be updated.

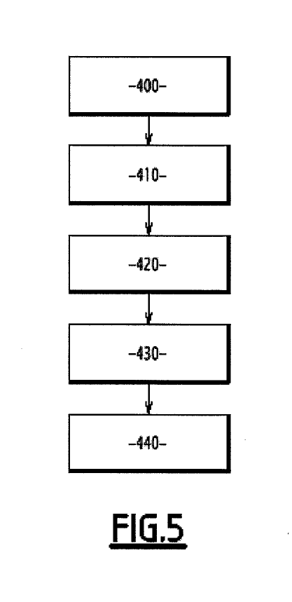

In reference to FIG. 4, the implementation of the archiving and retrieval methods in one embodiment of the invention will now be described in detail.

During a step 210, the user enters the URL “URLdoc1” (FIG. 2) of a Web document 20 he wishes to view in the navigation bar 68 using the keyboard 32. The browser application 56 orders the processing unit 38 to run the request application 54. The request application 54 generates a request sent using the communication means 36 to the Web server 16 on which the document is stored.

At the end of the step 210, the Web server 16 receives the request sent by the computer device 12.

During a step 220, the Web server 16 returns the content of the Web document 20.

At the end of this step 220, the computer device 12 receives the content of the document from its communication means 36. The document is then sent to the rendering management module 60 of the browser application 56.

During a step 230, the rendering management module 60 builds a source DOM representation 80 of the document thus transmitted and displays the DOM representation 80 on the screen 44.

During a step 240, the user interacts with the bookmark system 72 of the browser. The latter actuates the “Annote” scripted bookmark 74.

During a step 250, the request associated with the scripted bookmark 74 is sent by the request-sending application 50 via the communication means 36 to the annotation management server 18.

At the end of the step 250, the annotation management server 18 receives the request sent to it.

During a step 260, the annotation management server 18 deploys the annotation application 21 on the computer device 12, the preceding reception of the request by the annotation management server 18 having triggered the sending of the annotation application 21 to the computer device 12.

At the end of this step 260, the received application 21 is installed in the memory 52, then run, the toolbar 84 then being displayed above the Web document 20 to be annotated and inside the display frame 69.

During a step 270, the user selects the type of annotation 23 he wishes to add from among several types using the toolbar 84, so as to create the annotated Web document. These types thus correspond to a freehand drawing done by the user, an image, such as a smiley, or an arrow, a text field, free text, etc.

During a step 280, when the user has, using the sharing mode of the toolbar 84, commanded the transmission to another user of the URL associated with the annotated Web document, via the communication means 36, the archiving module 62 transmits the generated annotation data 22 to the annotation management server 18 via the communication means 36 for archiving.

During a step 285, the annotation management server 18 then stores the annotation data 22 matched with the URL identifying the Web document 20.

The sharing module 63 transmits the URL associated with the annotated Web document to the other user via the communication means 36. The URL associated with the annotated Web document is transmitted in the form of a hypertext link in an electronic mail or a message on a social network, such as Facebook© or Twitter©.

During a step 290, the other user using the other electronic device 19 receives a hypertext link corresponding to the URL associated with the annotated Web document and selects it. Selecting the hypertext link launches the execution of the browser application 56, if the latter has not been run previously, and commands the processing unit 38, via the browser application 56, to run the request application 54. The request application 54 then creates a request sent via the communication means 36 to the annotation management server 18, that request including the URL associated with the annotated Web document.

After the annotation management server 18 has received the request including the URL associated with the annotated Web document, it sends the electronic device 19 the annotation data 22 associated with the document that was previously stored during the step 285.

The central unit 38 of the retrieval device processes the received annotation data 22 and the annotation application 21 determines whether annotations 23 associated with the document are to be retrieved on a new target DOM representation 82 of the document as a function of the received annotation data 22.

During a step 300, the annotation application 21 of the retrieval device identifies each of the anchor elements 126 of the target representation 82 with which the annotations 23 are associated, as described above. This identification is done using standard JavaScript functions such as document.elementFromPoint( ) and by the standard attributes of HTML elements such as HTMLElementObject.tagName, HTMLElementObject.innerHTML, HTMLElementObject.id, imageObject.src, where HTMLElementObject represents an anchor element and imageObject represents an anchor element that is an image.

During a step 310, the annotation application 21 of the retrieval device restores the annotation 23 by means of the rendering management module 60 of the browser application 56 on the target representation 82 generated by the module 60 from the source DOM representation 80. This restoration is done using standard JavaScript functions such as document.getElementsByTagName( ) and by the standard attributes of HTML elements such as HTMLElementObject.innerHTML, HTMLElementObject.id, imageObject.src, where HTMLElementObject represents an anchor element and imageObject represents an anchor element that is an image.

During the retrieval of the representation of the annotated Web document 24, a selectable Web element, such as a hypertext link, can be selected even though it is surrounded or loaded with an annotation, such as a manual drawing, as described in more detail using FIG. 5, showing a flowchart of the method according to the invention.

During a step 320, the user may or may not proceed to create an annotation 23. In the affirmative, the user uses the application 21 to define the annotation(s) 23 that he wishes to add to the target representation 82 of the document as described above.

The annotation data 22 generated by creating one or more annotations 23 is stored in memory 52.

At the end of the step 320, the annotations 23 are displayed on a new target representation 82 generated by the rendering management module 60.

During a step 330, the archiving module 62 of the annotation application 21 sends, using the communication means 36, the annotation data 22 generated during the step 320 to the annotation management server 18. The latter then stores that data matched with the URL identifying the document.

At the end of the step 330, in the event the annotations created in step 320 and archived in step 330 are shared with another user, the method returns to step 290. Otherwise, the method returns to step 210.

In reference to FIG. 5, the implementation of the method according to the invention will now be described in detail.

During the step 400, a touch or mouse event associated with the upper Web element is detected. The detection of the event for example comprises triggering the capture of touch or mouse events associated with the upper Web element.

Following the detection of the event, the upper Web element is hidden during the step 410. The hiding step for example comprises positioning a CSS visibility attribute corresponding to the upper Web element in the hidden state.

The target Web element 25C corresponding to the lower Web element located directly below the detected event is then determined in the step 420, for example by running the standard DOM JavaScript routine document.elementFromPoint( )

Additionally, the upper Web element previously hidden is displayed again during the step 430, for example by positioning the CSS visibility attribute corresponding to the upper Web element in the visible state.

The length of a cycle comprising the steps 400 to 430 is very short and less than 10 ms. The user then continuously sees the annotation associated with the upper Web element 25A, due to retinal persistence, even though the upper Web element 25A is temporarily hidden during step 410.

During the step 440, the event is sent to the target Web element 25C previously determined, in order to perform the processing associated with the target Web element 25C, for example such as sending a request to the Web server 16 to display a new Web document 20 when the target Web element 25C is a hypertext link.

In the example embodiment of FIG. 5, the step for sending the event comprises creating a replica of the event, for example by running the standard DOM JavaScript routine document.createEvent( ), then sending the created replica to the target Web element, for example by running the standard DOM JavaScript routine element.dispatchEvent( ).

Alternatively, the upper Web element 25A previously hidden is displayed after the step 440 for sending the event to the target Web element 25C. If necessary, the time elapsed from the step 400 to the display of the upper Web element 25A that was previously hidden is also very short and smaller than 10 ms.

The steps 400 to 440 are included in the step 310 for displaying the representation of the annotated Web document 24.

The method according to the invention thus makes it possible, during retrieval of the representation of the annotated Web document 24, to select a selectable Web element, such as a hypertext link, using a mouse click or touchscreen, even though that element is surrounded or loaded with an annotation, such as a manual drawing. With the method of the state of the art, the hypertext link, although transparently visible to the user, cannot be selected, as it is continuously hidden by the upper Web element 25A.

The hypertext link is displayed highlighted, as shown in FIG. 3, so as to indicate that the link can be selected.

One can thus see that the retrieval method, by using the associated electronic device, makes it possible to select a target Web element, such as a hypertext link, around which an annotation has been added, so as to facilitate the use of the electronic device.

What is claimed is:

1. A method for retrieving a representation of an annotated Web document, the annotated Web document being a Web document having at least one added annotation, the annotated Web document including an upper Web element comprising at least one annotation and at least one lower Web element arranged below the upper Web element, the method being implemented by an electronic device comprising a viewer, an Internet browser application, and an annotation application, the method including the following step:
displaying the annotated Web document including the or each added annotation, wherein the displaying step includes:
(i) detecting a touch or mouse event associated with the upper Web element,
(ii) hiding the upper Web element after the detection of said event,
(iii) determining a target Web element corresponding to the lower Web element situated directly below said event, and
(iv) sending the event to the target Web element.

2. The method according to claim 1, wherein the detection of the event includes triggering the input of touch or mouse event(s) associated with the upper Web element.

3. The method according to claim 1, wherein the sending of the event includes creating a replica of the event, then sending the created replica to the target Web element.

4. The method according to claim 1, wherein the display step also includes, after step (iii):
displaying the upper Web element that was previously hidden.

5. The method according to claim 1, wherein the hiding of the upper Web element includes positioning a CSS visibility attribute corresponding to the upper Web element in the hidden state.

6. The method according to claim 4, wherein the hiding of the upper Web element includes positioning a CSS visibility attribute corresponding to the upper Web element in the hidden state, and wherein the display of the previously hidden upper Web element comprises positioning a CSS visibility attribute corresponding to the upper Web element in the visible state.

7. The method according to claim 1, wherein the Web document is an HTML document, and at least one of the upper and lower Web elements is an HTML element.

8. The method according to claim 7, wherein the upper Web element is the HTML element and is capable of performing dynamic rendering of an image using a script.

9. A computer program product including software instructions which, when run by a processing unit integrated into an electronic device including a data viewer and an Internet browser application, carries out the step, for which the annotation application is responsible, of the retrieval method according to claim 1, relative to the Web document.

10. An electronic device comprising:
a processing unit;
a data viewer;
an Internet browser application; and
an annotation application adapted to retrieve and/or add at least one annotation on a Web document, the annotation application including a module for reading the at least one annotation capable of retrieving a representation of an annotated Web document, the annotated Web document being the Web document in which at least one annotation has been added, the annotated Web document comprising an upper Web element including at least one annotation and at least one lower Web element arranged below the upper Web element,
wherein the read module comprises a detector for detecting a touch or mouse event associated with the upper Web element, a hider for hiding the upper Web element following the detection of said event, a determiner for determining a target Web element corresponding to the lower Web element located directly below said event, and a sender for sending the event to the target Web element.

11. The device according to claim 10, wherein the device includes an injector for injecting said annotation application into the document to add on to the document, and the browser application comprises a module for managing the graphic interface for accessing the Internet and a module for managing document rendering defining a context for running the rendering management module, said context comprising the source and processed data of the rendering management module,
wherein the annotation application is adapted to be run from the extended document only in the context of execution of the rendering management module on the source and processed data of the document rendering management module and using the same functions as the rendering management module, and
wherein the document processed by the browser application includes graphic elements, the annotation application being adapted to anchor an annotation to a point of a graphic element of the document independently of the coordinates of the graphic element in the document.
